(19) United States
(12) Patent Application Publication
(10) Pub. No.: US 2023/0212387 A1
(43) Pub. Date: Jul. 6, 2023

(54) LOW-REFRACTIVE-INDEX THERMOSETTING COMPOSITION, OPTICAL MEMBER FORMED THEREFROM, AND DISPLAY DEVICE

(71) Applicant: DONGJIN SEMICHEM CO., LTD., Incheon (KR)

(72) Inventors: Tai Hoon YEO, Hwaseong-si (KR); Hyoc Min YOUN, Hwaseong-si (KR); Sang Hoon LEE, Hwaseong-si (KR); Jong Hyuk PARK, Hwaseong-si (KR); Hyun Kyung PARK, Hwaseong-si (KR)

(21) Appl. No.: 18/179,742

(22) Filed: Mar. 7, 2023

Related U.S. Application Data
(63) Continuation of application No. PCT/KR2021/012976, filed on Sep. 23, 2021.

(30) Foreign Application Priority Data
Sep. 28, 2020 (KR) 10-2020-0125953
Apr. 20, 2021 (KR) 10-2021-0050938

(51) Int. Cl. C08L 63/00; C08K 7/26; C08K 3/011

(52) U.S. Cl. CPC C08L 63/00; C08K 7/26; C08K 3/011; C08L 2203/16; C08L 2203/20

(57) ABSTRACT

The present disclosure relates to a thermosetting composition, an optical member formed therefrom, and a display device, the composition comprising a thermosetting resin, gas-containing particles and a monomer or an oligomer having two or more thermosetting functional groups, thereby having optical effects such as a low refractive index of 1.40 or less on light with a wavelength of 450 nm, high light transmittance, and low haze.

### CROSS-REFERENCE TO RELATED APPLICATIONS

This application is a Continuation of PCT/KR2021/012976 filed on Sep. 23, 2021, which claims priority from Korean Application No. 10-2020-0125953, filed on Sep. 28, 2020, and Korean Application No. 10-2021-0050938, filed on Apr. 20, 2021.

The aforementioned applications are incorporated herein by reference in their entireties.

### TECHNICAL FIELD

The present disclosure relates to a thermosetting composition having a low refractive index, an optical member formed therefrom, and a display device.

### RELATED ART

Needs for technologies that improve light efficiency in organic light-emitting diode (OLED), quantum dot-organic light-emitting diode (QD-OLED), quantum nano-emitting diode (QNED), micro-LED, and image sensors to improve light efficiency are continuously increasing. The technology for improving light efficiency is technology necessary for reducing the reflectance of a display, improving the lifespan of an OLED, and increasing battery efficiency, and research and development for this technology have recently been actively conducted.

In order to improve light efficiency, a technology for lowering the refractive index of light at the boundary of the medium is required. The refractive index range that may be controlled by using organic compounds as a medium is known to have a theoretical lower limit of around 1.40 early to mid and thus is insufficient to improve light efficiency with conventional organic compounds. Therefore, in order to realize an optical member having a refractive index of 1.40 or less at the boundary of a medium, a hybrid technology including hollow silica in addition to organic compounds is required.

However, when hollow silica is mixed, the refractive index is lowered, but there are many technical limitations due to issues such as lowering of transmittance, haze, and lowering of upper and lower film adhesion due to compatibility problems with organic compounds.

Due to the various problems of the related art, the development of a technology that enables the formation of an optical film that exhibits low refractive properties, suppresses the decrease in transmittance and the increase in haze and exhibits excellent adhesive strength and heat resistance while exhibiting low refractive properties is being requested continuously.

### SUMMARY

An objective of the present disclosure is to provide a thermosetting composition having a low refractive index of light, excellent light transmittance, and excellent adhesive strength and heat resistance while suppressing an increase in a haze.

Another objective of the present disclosure is to provide an optical member, including a cured film cured by the included thermosetting composition.

Still, another objective of the present disclosure is to provide a display device including the optical member.

In order to achieve the above objective, a thermosetting composition according to an embodiment of the present disclosure comprises a thermosetting resin; gas-containing particles; and monomers or oligomers having two or more thermosetting functional groups.

In order to achieve the above objective, an optical member, according to another embodiment of the present disclosure, comprises a substrate and a cured film cured by the included thermosetting composition.

In order to achieve the above objective, a display device, according to another embodiment of the present disclosure, comprises the optical member.

When the thermosetting composition of the present disclosure is cured to form a cured film, it has effects of showing excellent adhesive force on the surface of the cured film, excellent heat resistance of the cured film itself, excellent light transmittance, and low haze optical characteristics, while having a low refractive index of 1.40 or less with respect to light of 450 nm wavelength.

A display device, according to an embodiment of the present disclosure, comprises an optical member prepared by using the thermosetting composition, thereby having an excellent effect in improving light efficiency.

### DETAILED DESCRIPTION

Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe its disclosure in the best way possible.

Therefore, since the configurations described in the embodiments and preparation examples described herein are only the most preferred embodiments of the present disclosure and do not represent all the technical ideas of the present disclosure, it should be understood that there may be various equivalents and modifications that may replace them at the time of the present application.

A thermosetting composition, according to an embodiment of the present disclosure, includes a thermosetting resin, gas-containing particles, and a monomer or oligomer having a thermosetting functional group in which the monomer or oligomer has two or more thermosetting functional groups.

The monomer or oligomer having two or more thermosetting functional groups provides an effect of further improving the thermosetting property of the composition by improving the thermosetting degree between the resin and the gas-containing particles.

The thermosetting resin may specifically be a resin containing at least one of an epoxy group, an oxetane group, or a hydroxyl group (OH) for thermosetting, and may be, for example, a thermosetting resin containing an epoxy group.

The thermosetting resin may specifically have a weight-average molecular weight in a range of 1,000 to 200,000. When the weight-average molecular weight of the thermosetting resin is less than 1,000, problems may occur on the low refractive thermosetting layer, lower adhesive force, inkjet processability, and slit coating properties, and when the weight-average molecular weight of the thermosetting resin is more than 200,000, the viscosity may be high, causing problems in inkjet discharge properties.

The gas-containing particles refer to an internal space (void) in which the solid particle is disconnected from the outside, and the internal space refers to a particle filled with gas. The particle diameter of the gas-containing particle means the length of the diameter based on the outer surface of the gas-containing particle.

The gas-containing particles serve to significantly lower the refractive index of the composition due to the internal space (void). However, since the gas-containing particles have poor compatibility with organic compounds, it is important to appropriately contain the number of gas-containing particles. Accordingly, the thermosetting composition, according to an embodiment of the present disclosure, comprises 30% to 80% by weight of the gas-containing particles with respect to the total weight of the composition so that a thermosetting composition having a refractive index of 1.40 or less with respect to light having a wavelength of 450 nm can be made. When the gas-containing particles are comprised in less than 30% by weight of the total weight of the composition, it may be difficult to realize a refractive index of 1.40 or less, and when the gas-containing particles are comprised in more than 80% by weight, compatibility with other organic compounds in the composition may be degraded, and transmittance and haze may be degraded, thereby decreasing adhesive strength after curing.

More specifically, when the gas-containing particles are included in an amount of 50% to 80% by weight based on the total weight of the thermosetting composition, a thermosetting composition having a lower refractive index of 1.25 or less with respect to light having a wavelength of 450 nm can be formed.

The gas-containing particles may be hollow organic or inorganic particles, for example, porogen or hollow silica, and hollow silica may be used as an embodiment of the present disclosure.

The gas-containing particles may improve the dispersibility of the particles by preventing the particles from agglomeration through a surface treatment process. When the gas-containing particles are agglomerated, compatibility with other organic compounds in the composition is decreased, resulting in lower transmittance and haze, and lower adhesive strength after curing.

The surface of the gas-containing particles may be specifically treated with at least one functional group selected from the group consisting of an alkyl group, an acryl group, a methacrylic group, an epoxy group, and a vinyl group.

In the process of surface treatment of the gas-containing particles, when the thickness of the surface treatment is less than 3 nm, the effect of the surface treatment is reduced, causing agglomeration between the gas-containing particles and an increase in a haze. When the thickness is thicker than 50 nm, a problem in that the refractive index of the composition may be deteriorated may occur. Therefore, the surface treatment of the gas-containing particles is preferable to perform to have a thickness in a range of 3 to 50 nm and may be performed to have a thickness in a range of 3 to 30 nm to realize a lower refractive index.

The D50 particle diameter of the gas-containing particles is preferably 30 to 150 nm, specifically 30 to 150 nm based on the D50 particle diameter measured by DLS Litesizer 500 (Anton Paar Co.). When the D50 particle diameter is less than 30 nm, a problem of lowering the refractive index may occur, and when the D50 particle diameter exceeds 150 nm, a problem of lowering transmittance and haze may occur due to a drop in dispersion margin, and a problem that the adhesive force to the upper and lower films is degraded may occur due to the lack of cross-linking with the resin.

When the gas-containing particles are included in the composition, curing of the composition is insufficient with only the thermosetting resin, and thus curing can be improved by additionally applying a monomer and/or oligomer containing a thermosetting functional group and further improving adhesive force to the low refractive layer and the lower film. The monomer or oligomer having a thermosetting functional group may specifically include an alicyclic epoxy structure having excellent reactivity to ensure thermosetting properties.

As a specific example, the monomer or oligomer having a thermosetting functional group may have one of the chemical structures represented by Chemical Formulae 1 to 24 below.

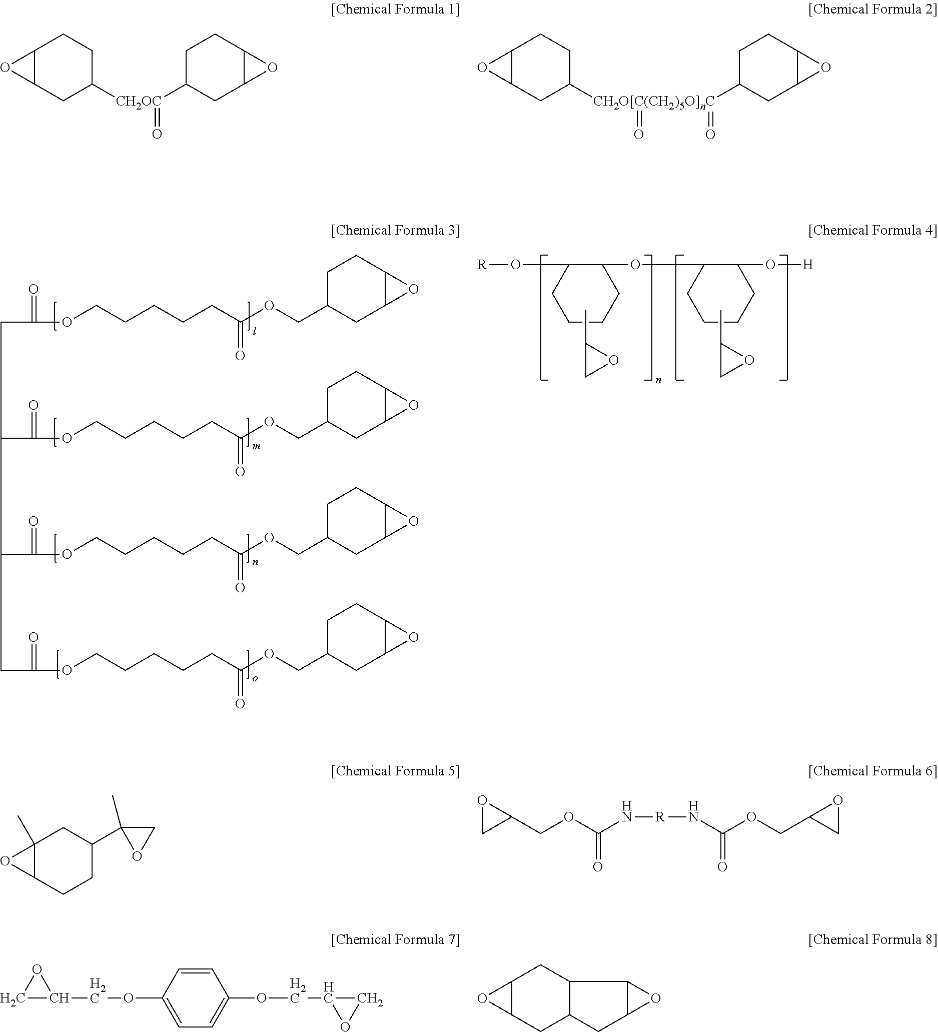

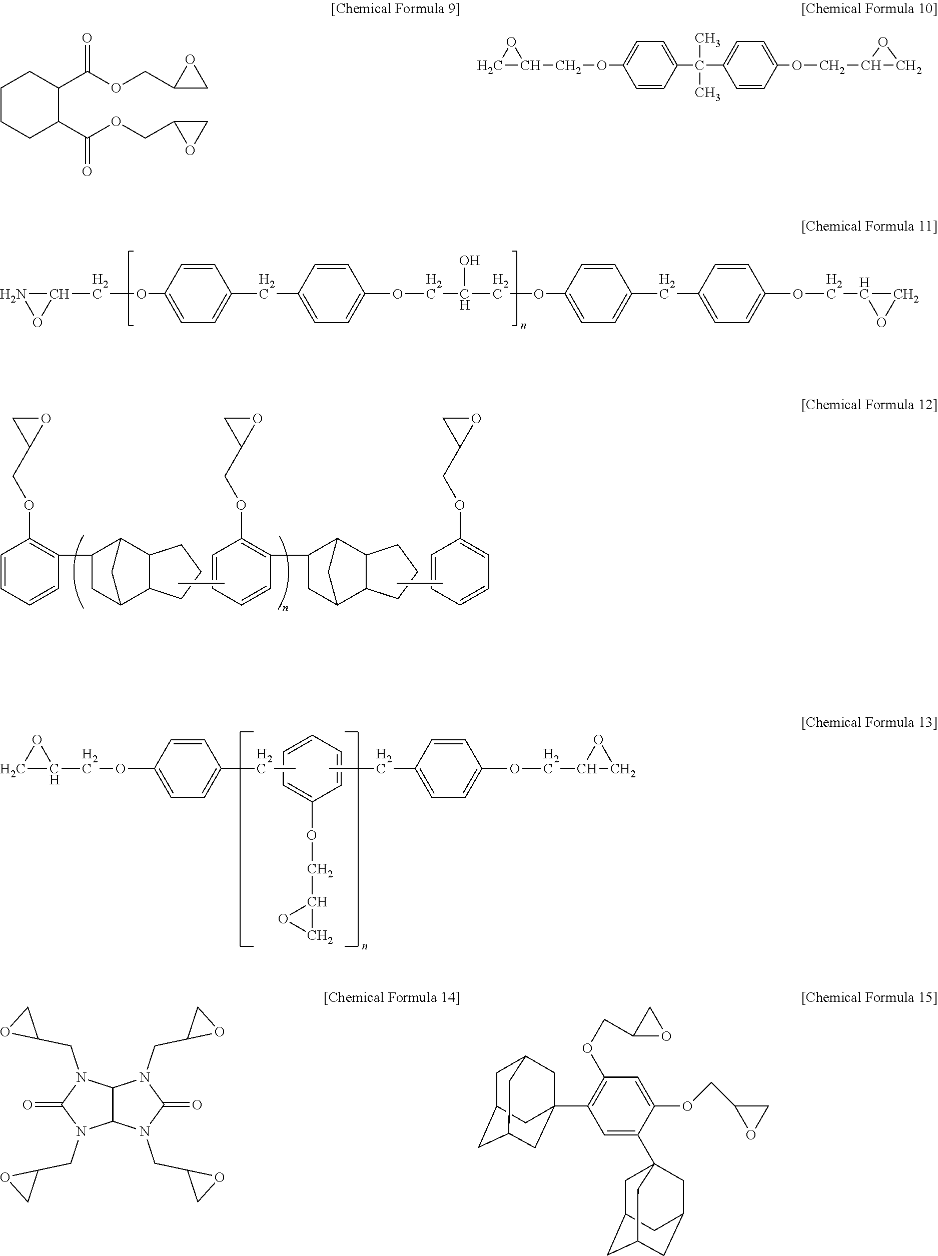

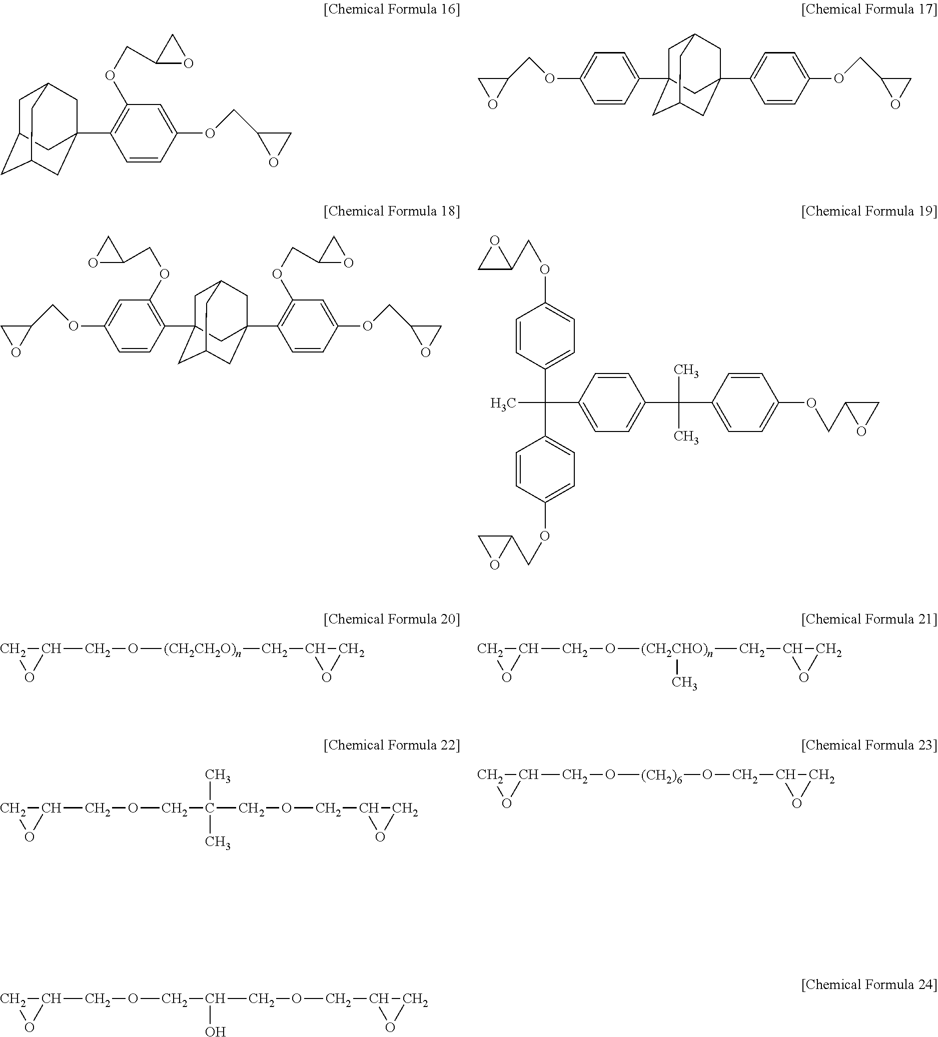

In Chemical Formula 4 and Chemical Formula 6, R each independently represents a hydrocarbon group having 1 to 10 carbon atoms, R in Chemical Formula 6 is one of alkyl, alkenyl, and alkoxy groups, and in Chemical Formulae 2 to 4, Chemical Formulae 11 and 23, Chemical Formulae 20 to 21, l, m, n, and o are each independently an integer of 1 to 30.

At this time, instead of the 4,4′-[1-[4-[1-[4-hydroxyphenyl]-1-methylethyl]phenyl]ethylidene] bisphenol used as the precursor of Chemical Formula 19, a compound with a chemical structure selected from Chemical Formulae 25 to 32 may be used.

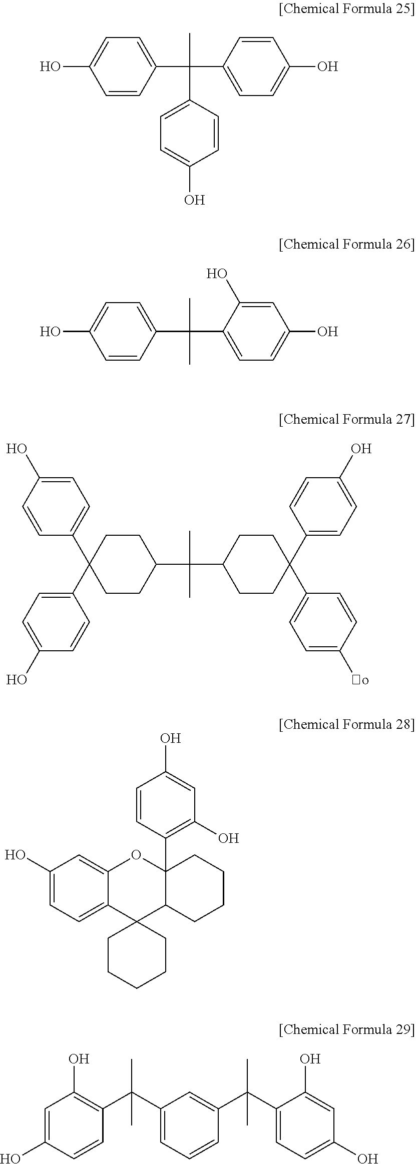

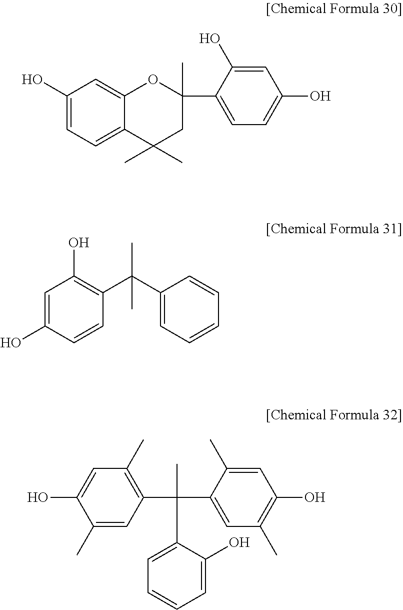 [SMILES: CC1(C)CC(C)(c2ccc(O)cc2O)Oc2cc(O)ccc21 ; CC(C)(c1ccccc1)c1ccc(O)cc1O ; Cc1cc(C(C)(c2cc(C)c(O)cc2C)c2ccccc2O)c(C)cc1O]

It is preferred that the specific composition ratio includes 1% to 69% by weight of thermosetting resin, 30% to 80% by weight of gas-containing particles, and 1% to 60% by weight of a monomer or oligomer having a thermosetting functional group in order to form a cured film with excellent upper and lower adhesive forces of the thermosetting composition and to realize excellent optical properties.

The formation of cured films with excellent upper and lower adhesive forces and excellent optical properties of the thermosetting composition is related to the total weight ratio of a thermosetting resin and a monomer or oligomer with a thermosetting functional group. Specifically, the total weight of the thermosetting resin and the monomer or oligomer with the thermosetting functional group may be 20 to 70% by weight based on the total composition.

The thermosetting composition may further include at least one additive selected from the group consisting of a silane coupling agent, an adhesive having an alkoxy group as a crosslinking site, and a surfactant to further improve upper and lower adhesive forces of a low refractive layer.

Specifically, the silane coupling agent may be included in an amount of 0.1 to 30 parts by weight based on 100 parts by weight of the thermosetting resin, when the silane coupling agent is included less than 0.1 parts by weight, the adhesive force margin may be degraded, and when the silane coupling agent is included more than 30 parts by weight, the storage stability problem may occur.

The silane coupling agent may include at least one species selected from th group consisting of, for example, (3-glycidoxypropyl) trimethoxy silane, (3-glycidoxypropyl)triethoxy silane, (3-glycidoxypropyl)methyldimethoxy silane, (3-glycidoxypropyl) methyldiethoxy silane, (3-glycidoxypropyl)dimethylethoxy silane, 3,4-epoxybutyltrimethoxysilane, 3,4-epoxybutyltriethoxysilane, 2-(3,4-epoxycyclohexyl)ethyltrimethoxy silane, 2-(3,4-epoxycyclohexyl)ethyltriethoxy silane, aminopropyltrimethoxy silane, aminopropyltriethoxy silane, 3-triethoxysily-N-(1,3 dimethyl-butylidene)propylamine, N-2(aminoethyl)3-aminopropyltrimethoxysilane, N-2(aminoethyl)3-aminopropyltrietoxysilane, N-2(aminoethyl)3-aminopropylmethyldimethoxysilane, N-phenyl-3-aminopropyltrimethoxysilane, and (3-isocyanatepropyl)triethoxy silane, but may be used without being limited to the above examples.

In addition, the adhesive having the alkoxy group as a cross-linking site may be specifically included in an amount of 0.1 to 30 parts by weight based on 100 parts by weight of the thermosetting resin. When the adhesive is included in more than 30 parts by weight, storage stability problems may occur.

In addition, the surfactant may be specifically included in an amount of 0.0001 to 5 parts by weight based on 100 parts by weight of the thermosetting resin, when the surfactant is included less than 0.0001 parts by weight, problems may occur in coating properties, and when the surfactant is included more than 5 parts by weight, coating bubbles may occur.

The thermosetting composition may further include at least one dispersant selected from the group consisting of an acrylic dispersant, an epoxy dispersant, and a silicone dispersant to improve dispersibility.

In addition, the thermosetting composition may further include at least one crosslinking accelerator selected from the group consisting of a thermal acid generator and a thermal base generator to promote curing.

The thermosetting composition may contain a solvent but may also be a solvent-free type that does not contain a solvent. When a solvent is included, the solvent serves to improve the compatibility or coating properties of the thermosetting resin and the gas-containing particles. At this time, in order to smoothly apply the thermosetting composition, the solvent may include at least one solvent selected from the group consisting of diethyleneglycoldimethyl ether, diethyleneglycolmethylethyl ether, propyleneglycolmethylether acetate, propyleneglycolethylether acetate, propyleneglycolpropylether acetate, propyleneglycolmethylether propionate, propyleneglycolethylether propionate, propyleneglycolpropylether propionate, propyleneglycolmethyl ether, propyleneglycolethyl ether, propyleneglycolpropyl ether, propyleneglycolbutyl ether, dipropyleneglycoldimethyl ether, dipropyleneglycoldiethyl ether, butyleneglycolmonomethyl ether, butyleneglycolmonoethyl ether, dibutyleneglycoldimethyl ether, dibutyleneglycoldiethyl ether, diethyleneglycolbutylmethyl ether, diethyleneglycolbutylethyl ether, triethyleneglycoldimethyl ether, triethyleneglycolbutylmethyl ether, diethyleneglycoltertiarybutyl ether, tetraethyleneglycoldimethyl ether, diethyleneglycolethylhexyl ether, diethyleneglycolmethylhexyl ether, dipropyleneglycolbutylmethyl ether, dipropyleneglycolethylhexyl ether, and dipropyleneglycolmethylhexyl ether.

The viscosity of the thermosetting composition may be adjusted by adjusting the content of the solvent, and the viscosity may be specifically 3 to 30 cP in order to realize both processability and excellent optical properties.

An optical member, according to an embodiment of the present disclosure, includes a substrate and a cured film, and the cured film is cured by the included thermosetting composition according to an embodiment of the present disclosure.

The optical member may implement excellent optical properties having a refractive index of 1.40 or less and a haze percentage of 3% or less for light having a wavelength of 450 nm.

The optical member may be, for example, a light extraction layer or a refractive index control layer, but is not limited to the above example.

A display device, according to an embodiment of the present disclosure, includes the optical member, and may be, for example, an OLED, QLED, or micro-LED display device having excellent luminance, but is not limited to the above example.

Hereinafter, embodiments of the present disclosure will be described in detail so that those skilled in the art can easily implement the present disclosure. However, the present disclosure may be embodied in many different forms and is not limited to the embodiments and preparation examples described herein.

### PREPARATION EXAMPLE 1: SYNTHESIS OF THERMOSETTING RESIN

As an example of the thermosetting resin of the thermosetting composition according to one aspect of the present disclosure, a resin containing an epoxy group, an oxetane group, a hydroxyl group, and the like was used. Synthesis examples of the thermosetting resin included in the thermosetting composition are shown in Synthesis Examples 1 to 10 below, and synthesis examples of the thermosetting resin for comparing effect differences with the above Synthesis Examples are shown in Reference Synthesis Examples 1 to 3 below.

### SYNTHESIS EXAMPLE 1

In a flask equipped with a cooling tube and a stirrer, 500 parts by weight of tetrahydroxyfuran and 100 parts by weight of glycidyl methacrylate based on 10 parts by weight of 2,2′-azobis (2,4-dimethylvaleronitrile) were added, and nitrogen was purged and stirred slowly. The temperature of the reaction solution was raised to 60° C., and a polymer solution containing an acrylic copolymer was prepared while maintaining this temperature for 24 hours.

100 parts by weight of the polymer solution containing the acrylic copolymer was precipitated based on 1,000 parts by weight of normal hexane. Next, the waste liquid was removed through a filtering process using a mesh and then vacuum-dried at 30° C. or less to prepare a thermosetting resin containing an epoxy group having a weight-average molecular weight of 10,000.

At this time, the weight-average molecular weight was measured using a standard method of gel permeation chromatography (GPC) using Waters' e2695 Alliance Separation Module.

The weight-average molecular weight is a polystyrene converted average-molecular weight measured using GPC.

### SYNTHESIS EXAMPLE 2

A thermosetting resin containing an epoxy group was prepared in the same manner as in Synthesis Example 1, except that 80 parts by weight of meta-glycidyl methacrylate and 20 parts by weight of styrene were used instead of 100 parts by weight of glycidyl methacrylate.

The weight-average molecular weight of the thermosetting resin containing epoxy group synthesized according to Synthesis Example 2 is 8,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 3

In Synthesis Example 1, a thermosetting resin containing an oxetane group was prepared in the same manner as in Synthesis Example 1, except that 60 parts by weight of 3-ethyl 3-oxatanyl methyl methacrylate and 40 parts by weight of ethoxyethoxy ethyl acrylate were used instead of 100 parts by weight of glycidyl methacrylate.

The weight-average molecular weight of the thermosetting resin containing an oxetane group synthesized according to Synthesis Example 3 is 5,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 4

In Synthesis Example 1, a thermosetting resin containing an epoxy group was prepared in the same manner as in Synthesis Example 1, except that 1.1 parts by weight was used instead of 10 parts by weight of 2,2′-azobis(2,4-dimethylvaleronitrile) as an initiator, and the temperature was maintained for 20 hours by raising the temperature of the reaction solution to 60° C.

The weight-average molecular weight of the thermosetting resin containing epoxy group synthesized according to Synthesis Example 4 is 200,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 5

In Synthesis Example 1, a thermosetting resin containing an epoxy group was prepared in the same manner as in Synthesis Example 1, except that 29 parts by weight were used instead of 10 parts by weight of 2,2′-azobis(2,4-dimethylvaleronitrile) as an initiator, and the temperature was maintained for 6 hours by raising the temperature of the reaction solution to 60° C.

The weight-average molecular weight of the thermosetting resin containing epoxy group synthesized according to Synthesis Example 5 is 1,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 6

In Synthesis Example 1, a thermosetting resin containing a hydroxyl group was prepared in the same manner as in Synthesis Example 1, except that 60 parts by weight of 2-hydroxyethyl acrylate and 40 parts by weight of perfluorooctylethyl acrylate were used instead of 100 parts by weight of glycidyl methacrylate, and 5 parts by weight were used instead of 10 parts by weight of 2,2′-azobis(2,4-dimethylvaleronitrile) as an initiator, and the temperature was maintained for 24 hours by raising the temperature of the reaction solution to 60° C.

The weight-average molecular weight of the thermosetting resin containing hydroxyl group synthesized according to Synthesis Example 6 is 52,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 7

In Synthesis Example 1, a thermosetting resin containing an epoxy group was prepared in the same manner as in Example 1, except that 60 parts by weight of 3,4-epoxycyclohexylmethyl methacrylate and 40 parts by weight of lauryl methacrylate were used instead of 100 parts by weight of glycidyl methacrylate, and 3 parts by weight were used instead of 10 parts by weight of 2,2′-azobis (2,4-dimethylvaleronitrile) as an initiator, and the temperature was maintained for 24 hours by raising the temperature of the reaction solution to 60° C.

The weight-average molecular weight of the thermosetting resin containing epoxy group synthesized according to Synthesis Example 7 is 106,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 8

80 parts by weight of 3-glycidoxypropyl trimethoxysilane and 20 parts by weight of tetraethoxysilane were added as reactive silanes to a flask equipped with a cooling tube and a stirrer, and the mixture was purged with nitrogen and gently stirred. After adding 50 parts by weight of ultrapure water and 4 parts by weight of oxalic acid as a catalyst to the reaction solution, the mixture was gently stirred again. After 1 hour, the temperature of the reaction solution was raised to 60° C., maintained at this temperature for 10 hours to polymerize, and then the reaction was terminated by cooling to room temperature. Water and alcohol components generated during the reaction were removed by vacuum drying at 30° C. or less to prepare a thermosetting resin including an epoxy group and a hydroxyl group with a weight-average molecular weight of 3,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 9

In Synthesis Example 8, a thermosetting resin containing an epoxy group and a hydroxyl group was prepared in the same manner as in Synthesis Example 1, except that 40 parts by weight of 3-glycidoxypropyl trimethoxy silane and 60 parts by weight of tetraethoxy silane were used instead of 80 parts by weight of 3-glycidoxypropyl trimethoxy silane and 20 parts by weight of tetraethoxy silane.

The weight-average molecular weight of the thermosetting resin containing an epoxy group and a hydroxyl group synthesized according to Synthesis Example 9 is 15,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### SYNTHESIS EXAMPLE 10

In Synthesis Example 8, a thermosetting resin containing an epoxy group and a hydroxyl group was prepared in the same manner as in Synthesis Example 1, except that 20 parts by weight of 2-(3,4 epoxycyclohexyl) ethyl trimethoxy silane and 80 parts by weight of tetramethoxy silane were used instead of 80 parts by weight of 3-glycidoxypropyl trimethoxy silane.

The weight-average molecular weight of the thermosetting resin containing an epoxy group and a hydroxyl group synthesized according to Synthesis Example 10 is 46,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Reference Synthesis Example 1

In Synthesis Example 1, a thermosetting resin containing an epoxy group was prepared in the same manner as in Synthesis Example 1, except that 30 parts by weight were used instead of 10 parts by weight of 2,2′-azobis(2,4-dimethylvaleronitrile) as an initiator, and the temperature was maintained for 6 hours by raising the temperature of the reaction solution to 60° C.

The weight-average molecular weight of the thermosetting resin containing an epoxy group synthesized according to Reference Synthesis Example 1 is 900.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Reference Synthesis Example 2

In Synthesis Example 1, a thermosetting resin containing an epoxy group was prepared in the same manner as in Synthesis Example 1, except that 1 part by weight was used instead of 10 parts by weight of 2,2′-azobis(2,4-dimethylvaleronitrile) as an initiator, and the temperature was maintained for 24 hours by raising the temperature of the reaction solution to 60° C.

The weight-average molecular weight of the thermosetting resin containing an epoxy group synthesized according to Reference Synthesis Example 2 is 201,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Reference Synthesis Example 3

In Synthesis Example 8, a thermosetting resin containing an epoxy group and a hydroxyl group was prepared in the same manner as in Synthesis Example 7, except that 30 parts by weight of 3-glycidoxypropyl trimethoxy silane and 70 parts by weight of tetraethoxy silane was used instead of 80 parts by weight of 3-glycidoxypropyl trimethoxy silane and 20 parts by weight of tetraethoxy silane as the reactive silane.

The weight-average molecular weight of the thermosetting resin containing an epoxy group and a hydroxyl group synthesized according to Reference Synthesis Example 3 is 250,000.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Comparative Synthesis Example 1

In Synthesis Example 1, a resin containing no thermosetting groups having a weight-average molecular weight of 9,000 in the same manner as in Synthesis Example 1, except that 100 parts by weight of lauryl methacrylate were used instead of 100 parts by weight of glycidyl methacrylate.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Comparative Synthesis Example 2

In Synthesis Example 1, a resin containing no thermosetting group having a weight-average molecular weight of 135,000 was prepared in the same manner as in Synthesis Example 1, except that 50 parts by weight of lauryl methacrylate and 50 parts by weight of styrene were used instead of 100 parts by weight of glycidyl methacrylate, and 1.5 parts by weight was used instead of 10 parts by weight of 2,2′-azobis (2,4-dimethylvaleronitrile) as an initiator.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### Comparative Synthesis Example 3

In Synthesis Example 1, a resin containing no thermosetting group having a weight-average molecular weight of 25,000 was prepared in the same manner as in Synthesis Example 1, except that 50 parts by weight of lauryl methacrylate and 50 parts by weight of ethylmethacrylate were used instead of 100 parts by weight of glycidyl methacrylate, and 5 parts by weight were used instead of 10 parts by weight of 2,2′-azobis (2,4-dimethylvaleronitrile) as an initiator.

At this time, the weight-average molecular weight was the polystyrene converted weight-average molecular weight measured using GPC, and the weight-average molecular weight was measured using the standard method of gel permeation chromatography (GPC) used by Waters' e2695 Alliance Separation Module.

### PREPARATION EXAMPLE 2: PREPARATION OF LOW-REFRACTIVE-INDEX THERMOSETTING COMPOSITION AND OPTICAL FILM

The thermosetting compositions of Synthesis Examples 1 to 64, Comparative Synthesis Examples 1 to 6, and Reference Synthesis Examples 1 to 15 were respectively prepared in the compositions shown in Tables 1 to 3 below using the resins synthesized in Synthesis Examples, Reference Synthesis Examples, and Comparative Synthesis Examples. At this time, hollow silica was used as the gas-containing particle, and an epoxy monomer was used as a monomer having a thermosetting functional group.

At this time, a composition containing epoxy resin, epoxy monomer or oligomer, and hollow silica is injected into inkjet equipment and slit coater equipment, applied to SiOₓ film, prebaked, and a single film was formed to have a thickness of 2.5 μm.

Thereafter, heat treatment was performed at 180° C./30 min in a convection oven to prepare a cured film of a low-refractive-index thermosetting composition. At this time, the thickness of the formed cured film was maintained at 2 μm.

TABLE 1

| | | | | | Hollow silica | | | | | |
|---|---|---|---|---|---|---|---|---|---|---|
| | | | | | Type of | | Particle | | | |
| | Resin | | Epoxy monomer | | surface | Processing | size | | Solvent | Solid |
| Division | Structure | Content | Structure | Content | treatment | thickness | (nm) | Content | Type | content |
| Example 1 | Synthesis | 60% | Chemical | 10% | Acryl | 3 | 30 | 30% | skip | 100% |
| | Example 1 | | Formula 1 | | | | | | | |
| Example 2 | Synthesis | 50% | Chemical | 15% | Acryl | 10 | 50 | 35% | skip | 100% |
| | Example 2 | | Formula 2 | | | | | | | |
| Example 3 | Synthesis | 40% | Chemical | 20% | Acryl | 20 | 70 | 40% | skip | 100% |
| | Example 3 | | Formula 5 | | | | | | | |
| Example 4 | Synthesis | 30% | Chemical | 25% | Acryl | 30 | 100 | 45% | skip | 100% |
| | Example 4 | | Formula 7 | | | | | | | |
| Example 5 | Synthesis | 20% | Chemical | 31% | Acryl | 40 | 150 | 49% | skip | 100% |
| | Example 5 | | Formula 9 | | | | | | | |
| Example 6 | Synthesis | 10% | Chemical | 60% | Acryl | 50 | 30 | 30% | skip | 100% |
| | Example 6 | | Formula 14 | | | | | | | |
| Example 7 | Synthesis | 5% | Chemical | 60% | Vinyl | 3 | 50 | 35% | skip | 100% |
| | Example 7 | | Formula 17 | | | | | | | |
| Example 8 | Synthesis | 2% | Chemical | 58% | Vinyl | 10 | 70 | 40% | skip | 100% |
| | Example 8 | | Formula 22 | | | | | | | |
| Example 9 | Synthesis | 53% | Chemical | 2% | Vinyl | 20 | 100 | 45% | skip | 100% |
| | Example 9 | | Formula 23 | | | | | | | |
| Example 10 | Synthesis | 46% | Chemical | 5% | Vinyl | 30 | 150 | 49% | skip | 100% |
| | Example 10 | | Formula 24 | | | | | | | |
| Example 11 | Synthesis | 60% | Chemical | 10% | Vinyl | 40 | 30 | 30% | skip | 100% |
| | Example 1 | | Formula 1 | | | | | | | |
| Example 12 | Synthesis | 45% | Chemical | 20% | Vinyl | 50 | 50 | 35% | skip | 100% |
| | Example 2 | | Formula 2 | | | | | | | |
| Example 13 | Synthesis | 30% | Chemical | 30% | Methyl | 3 | 70 | 40% | skip | 100% |
| | Example 3 | | Formula 5 | | | | | | | |
| Example 14 | Synthesis | 15% | Chemical | 40% | Methyl | 10 | 100 | 45% | skip | 100% |
| | Example 4 | | Formula 7 | | | | | | | |
| Example 15 | Synthesis | 21% | Chemical | 30% | Methyl | 20 | 150 | 49% | skip | 100% |
| | Example 5 | | Formula 9 | | | | | | | |
| Example 16 | Synthesis | 50% | Chemical | 20% | Methyl | 30 | 30 | 30% | skip | 100% |
| | Example 6 | | Formula 14 | | | | | | | |
| Example 17 | Synthesis | 50% | Chemical | 15% | Methyl | 40 | 50 | 35% | skip | 100% |
| | Example 7 | | Formula 17 | | | | | | | |
| Example18 | Synthesis | 50% | Chemical | 10% | Methyl | 50 | 70 | 40% | skip | 100% |
| | Example 8 | | Formula 22 | | | | | | | |
| Example 19 | Synthesis | 25% | Chemical | 30% | Epoxy | 3 | 100 | 45% | skip | 100% |
| | Example 9 | | Formula 23 | | | | | | | |
| Example 20 | Synthesis | 40% | Chemical | 11% | Epoxy | 10 | 150 | 49% | skip | 100% |
| | Example 10 | | Formula 24 | | | | | | | |
| Example 21 | Synthesis | 40% | Chemical | 10% | Epoxy | 20 | 30 | 50% | skip | 100% |
| | Example 1 | | Formula 1 | | | | | | | |
| Example 22 | Synthesis | 35% | Chemical | 10% | Epoxy | 30 | 50 | 55% | skip | 100% |
| | Example 2 | | Formula 2 | | | | | | | |
| Example 23 | Synthesis | 30% | Chemical | 10% | Epoxy | 40 | 70 | 60% | skip | 100% |
| | Example 3 | | Formula 5 | | | | | | | |
| Example 24 | Synthesis | 20% | Chemical | 10% | Epoxy | 50 | 100 | 70% | skip | 100% |
| | Example 4 | | Formula 7 | | | | | | | |
| Example 25 | Synthesis | 10% | Chemical | 10% | Acryl | 3 | 150 | 80% | skip | 100% |
| | Example 5 | | Formula 9 | | | | | | | |
| Example 26 | Synthesis | 10% | Chemical | 40% | Acryl | 10 | 30 | 50% | PGMEA | 10% |
| | Example 6 | | Formula 14 | | | | | | | |
| Example 27 | Synthesis | 10% | Chemical | 35% | Acryl | 20 | 50 | 55% | MMP | 10% |
| | Example 7 | | Formula 17 | | | | | | | |
| Example 28 | Synthesis | 10% | Chemical | 30% | Acryl | 30 | 70 | 60% | EEP | 10% |
| | Example 8 | | Formula 22 | | | | | | | |
| Example 29 | Synthesis | 10% | Chemical | 20% | Acryl | 40 | 100 | 70% | MEDG | 10% |
| | Example 9 | | Formula 23 | | | | | | | |
| Example 30 | Synthesis | 10% | Chemical | 10% | Acryl | 50 | 150 | 80% | DEDG | 10% |
| | Example 10 | | Formula 24 | | | | | | | |
| Example 31 | Synthesis | 60% | Chemical | 10% | Vinyl | 3 | 30 | 30% | PGMEA | 20% |
| | Example 1 | | Formula 1 | | | | | | | |
| Example 32 | Synthesis | 50% | Chemical | 15% | Vinyl | 10 | 50 | 35% | MMP | 20% |
| | Example 2 | | Formula 2 | | | | | | | |
| Example 33 | Synthesis | 40% | Chemical | 20% | Vinyl | 20 | 70 | 40% | EEP | 20% |
| | Example 3 | | Formula 5 | | | | | | | |
| Example 34 | Synthesis | 30% | Chemical | 25% | Vinyl | 30 | 100 | 45% | MEDG | 20% |
| | Example 4 | | Formula 7 | | | | | | | |
| Example 35 | Synthesis | 20% | Chemical | 50% | Vinyl | 40 | 150 | 30% | DEDG | 20% |
| | Example 5 | | Formula 9 | | | | | | | |
| Example 36 | Synthesis | 10% | Chemical | 55% | Vinyl | 50 | 30 | 35% | PGMEA | 30% |
| | Example 6 | | Formula 14 | | | | | | | |
| Example 37 | Synthesis | 5% | Chemical | 55% | Methyl | 3 | 50 | 40% | MMP | 30% |
| | Example 7 | | Formula 17 | | | | | | | |
| Example 38 | Synthesis | 2% | Chemical | 53% | Methyl | 10 | 70 | 45% | EEP | 30% |
| | Example 8 | | Formula 22 | | | | | | | |
| Example 39 | Synthesis | 10% | Chemical | 60% | Methyl | 20 | 100 | 30% | MEDG | 30% |
| | Example 9 | | Formula 23 | | | | | | | |
| Example 40 | Synthesis | 15% | Chemical | 50% | Methyl | 30 | 150 | 35% | DEDG | 30% |
| | Example 10 | | Formula 24 | | | | | | | |

TABLE 2

| | | | | | Hollow silica | | | | | |
|---|---|---|---|---|---|---|---|---|---|---|
| | | | | | Type of | | Particle | | | |
| | Resin | | Epoxy monomer | | surface | Processing | size | | Solvent | Solid |
| Division | Structure | Content | Structure | Content | treatment | thickness | (nm) | Content | Type | content |
| Example 41 | Synthesis | 20% | Chemical | 40% | Methyl | 40 | 30 | 40% | PGMEA | 40% |
| | Example 1 | | Formula 1 | | | | | | | |
| Example 42 | Synthesis | 25% | Chemical | 30% | Methyl | 50 | 50 | 45% | MMP | 40% |
| | Example 2 | | Formula 2 | | | | | | | |
| Example 43 | Synthesis | 50% | Chemical | 20% | Epoxy | 3 | 70 | 30% | EEP | 40% |
| | Example 3 | | Formula 5 | | | | | | | |
| Example 44 | Synthesis | 55% | Chemical | 10% | Epoxy | 10 | 100 | 35% | MEDG | 40% |
| | Example 4 | | Formula 7 | | | | | | | |
| Example 45 | Synthesis | 55% | Chemical | 5% | Epoxy | 20 | 150 | 40% | DEDG | 40% |
| | Example 5 | | Formula 9 | | | | | | | |
| Example 46 | Synthesis | 53% | Chemical | 2% | Epoxy | 30 | 30 | 45% | PGMEA | 50% |
| | Example 6 | | Formula 14 | | | | | | | |
| Example 47 | Synthesis | 20% | Chemical | 50% | Epoxy | 40 | 50 | 30% | MMP | 50% |
| | Example 7 | | Formula 17 | | | | | | | |
| Example 48 | Synthesis | 30% | Chemical | 35% | Epoxy | 50 | 70 | 35% | EEP | 50% |
| | Example 8 | | Formula 22 | | | | | | | |
| Example 49 | Synthesis | 40% | Chemical | 20% | Dimethyl | 3 | 100 | 40% | MEDG | 50% |
| | Example 9 | | Formula 23 | | | | | | | |
| Example 50 | Synthesis | 45% | Chemical | 10% | Dimethyl | 10 | 150 | 45% | DEDG | 50% |
| | Example 10 | | Formula 24 | | | | | | | |
| Example 51 | Synthesis | 69% | Chemical | 1% | Acryl | 20 | 30 | 30% | MEDG | 10% |
| | Example 11 | | Formula 1 | | | | | | | |
| Example 52 | Synthesis | 60% | Chemical | 5% | Acryl | 30 | 50 | 35% | DEDG | 20% |
| | Example 12 | | Formula 2 | | | | | | | |
| Example 53 | Synthesis | 50% | Chemical | 10% | Methacryl | 40 | 70 | 40% | MEDG | 30% |
| | Example 13 | | Formula 5 | | | | | | | |
| Example 54 | Synthesis | 35% | Chemical | 20% | Methacryl | 50 | 100 | 45% | DEDG | 40% |
| | Example 14 | | Formula 7 | | | | | | | |
| Example 55 | Synthesis | 50% | Chemical | 1% | Methacryl | 3 | 150 | 49% | skip | 100% |
| | Example 15 | | Formula 9 | | | | | | | |
| Example 56 | Synthesis | 50% | Chemical | 20% | Methacryl | 10 | 30 | 30% | skip | 100% |
| | Example 16 | | Formula 14 | | | | | | | |
| Example 57 | Synthesis | 50% | Chemical | 15% | Methacryl | 20 | 50 | 35% | skip | 100% |
| | Example 17 | | Formula 17 | | | | | | | |
| Example 58 | Synthesis | 50% | Chemical | 10% | Methacryl | 30 | 70 | 40% | skip | 100% |
| | Example 11 | | Formula 22 | | | | | | | |
| Example 59 | Synthesis | 50% | Chemical | 5% | Epoxy | 40 | 100 | 45% | skip | 100% |
| | Example 12 | | Formula 23 | | | | | | | |
| Example 60 | Synthesis | 1% | Chemical | 50% | Vinyl | 50 | 150 | 49% | skip | 100% |
| | Example 13 | | Formula 24 | | | | | | | |
| Example 61 | Synthesis | 20% | Chemical | 50% | Epoxy | 20 | 30 | 30% | skip | 100% |
| | Example 14 | | Formula 7 | | | | | | | |
| Example 62 | Synthesis | 15% | Chemical | 50% | Vinyl | 30 | 50 | 35% | skip | 100% |
| | Example 15 | | Formula 9 | | | | | | | |
| Example 63 | Synthesis | 10% | Chemical | 50% | Epoxy | 40 | 70 | 40% | skip | 100% |
| | Example 16 | | Formula 14 | | | | | | | |
| Example 64 | Synthesis | 5% | Chemical | 50% | Vinyl | 50 | 100 | 45% | skip | 100% |
| | Example 17 | | Formula 17 | | | | | | | |

TABLE 3

| | | | | | Hollow silica | | | | | |
|---|---|---|---|---|---|---|---|---|---|---|
| | | | | | Type of | | Particle | | | |
| | Resin | | Epoxy monomer | | surface | Processing | size | | Solvent | Solid |
| Division | Structure | Content | Structure | Content | treatment | thickness | (nm) | Content | Type | content |
| Comparative | Comparative | 60% | Chemical | 10% | Acryl | 3 | 30 | 30% | skip | 100% |
| Example 1 | Synthesis | | Formula 22 | | | | | | | |
| | Example 1 | | | | | | | | | |
| Comparative | Comparative | 50% | Chemical | 15% | Methacryl | 10 | 50 | 35% | skip | 100% |
| Example 2 | Synthesis | | Formula 23 | | | | | | | |
| | Example 2 | | | | | | | | | |
| Comparative | Comparative | 40% | Chemical | 20% | Epoxy | 20 | 70 | 40% | skip | 100% |
| Example 3 | Synthesis | | Formula 24 | | | | | | | |
| | Example 3 | | | | | | | | | |
| Comparative | Comparative | 30% | Chemical | 25% | Vinyl | 30 | 100 | 45% | PGMEA | 10% |
| Example 4 | Synthesis | | Formula 1 | | | | | | | |
| | Example 1 | | | | | | | | | |
| Comparative | Comparative | 20% | Chemical | 31% | Dimethyl | 40 | 150 | 49% | PGMEA | 20% |
| Example 5 | Synthesis | | Formula 2 | | | | | | | |
| | Example 2 | | | | | | | | | |
| Comparative | Comparative | 10% | Chemical | 60% | Acryl | 50 | 30 | 30% | PGMEA | 30% |
| Example 6 | Synthesis | | Formula 5 | | | | | | | |
| | Example 3 | | | | | | | | | |
| Reference | Synthesis | 50% | Chemical | 20% | Acryl | 2 | 30 | 30% | skip | 100% |
| Example 1 | Example 1 | | Formula 1 | | | | | | | |
| Reference | Synthesis | 25% | Chemical | 30% | Acryl | 51 | 70 | 45% | skip | 100% |
| example 2 | Example 2 | | Formula 2 | | | | | | | |
| Reference | Synthesis | 51% | Chemical | 20% | Acryl | 10 | 100 | 29% | skip | 100% |
| example 3 | Example 3 | | Formula 5 | | | | | | | |
| Reference | Synthesis | 50% | Chemical | 30% | Acryl | 15 | 150 | 20% | skip | 100% |
| example 4 | Example 4 | | Formula 7 | | | | | | | |
| Reference | Synthesis | 9% | Chemical | 10% | Acryl | 20 | 30 | 81% | skip | 100% |
| Example 5 | Example 5 | | Formula 9 | | | | | | | |
| Reference | Synthesis | 10% | Chemical | 5% | Acryl | 30 | 100 | 85% | PGMEA | 10% |
| Example 6 | Example 6 | | Formula 14 | | | | | | | |
| Reference | Synthesis | 50% | Chemical | 20% | Vinyl | 3 | 151 | 30% | PGMEA | 20% |
| Example 7 | Example 7 | | Formula 17 | | | | | | | |
| Reference | Synthesis | 25% | Chemical | 30% | Vinyl | 5 | 200 | 45% | PGMEA | 30% |
| Example 8 | Example 8 | | Formula 22 | | | | | | | |
| Reference | Synthesis | 50% | Chemical | 20% | Vinyl | 10 | 29 | 30% | PGMEA | 40% |
| Example 9 | Example 9 | | Formula 23 | | | | | | | |
| Reference | Synthesis | 25% | Chemical | 30% | Vinyl | 15 | 25 | 45% | PGMEA | 50% |
| Example 10 | Example 10 | | Formula 24 | | | | | | | |
| Reference | — | skip | Chemical | 70% | Vinyl | 20 | 30 | 30% | MEDG | 10% |
| Example 11 | | | Formula 1 | | | | | | | |
| Referene | Reference | 45% | Chemical | 10% | Vinyl | 30 | 70 | 45% | MEDG | 20% |
| Example 12 | Synthesis | | Formula 2 | | | | | | | |
| | Example 1 | | | | | | | | | |
| Reference | Reference | 20% | Chemical | 50% | Epoxy | 3 | 100 | 30% | MEDG | 30% |
| Example 13 | Synthesis | | Formula 5 | | | | | | | |
| | Example 2 | | | | | | | | | |
| Reference | Reference | 25% | Chemical | 30% | Epoxy | 5 | 150 | 45% | MEDG | 40% |
| Example 14 | Synthesis | | Formula 7 | | | | | | | |
| | Example 3 | | | | | | | | | |
| Reference | Synthesis | 55% | — | skip | Epoxy | 10 | 30 | 45% | MEDG | 50% |
| Example 15 | Example 1 | | | | | | | | | |

The structures of the epoxy monomers in Tables 1 to 3 are as follows.

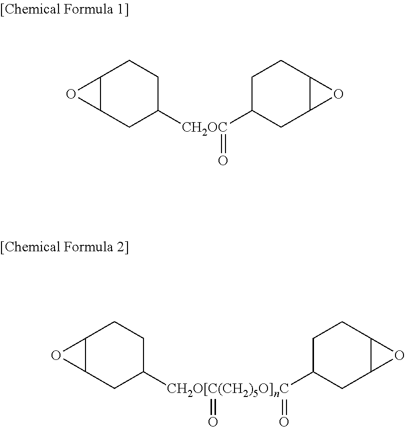

(The detailed structure of Chemical Formula 2 used in the Examples of the present disclosure is a structure in which n is 2)

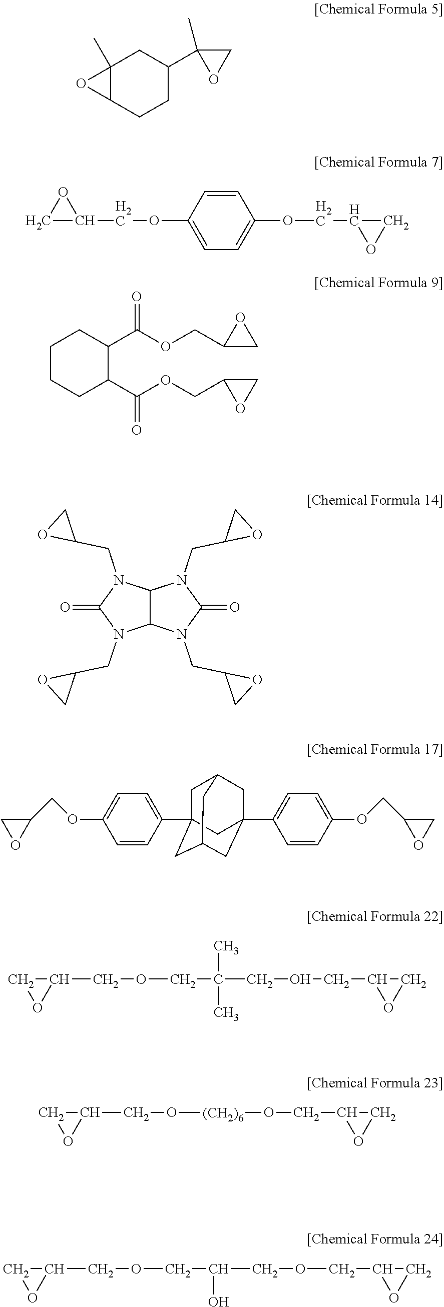

### EXPERIMENTAL EXAMPLE: MEASUREMENT OF PHYSICAL PROPERTIES OF THE OPTICAL FILM

For the optical films of Reference Examples and Examples prepared according to Preparation Example 2, physical properties such as refractive index, haze, viscosity, and the like were measured by the following methods, and the results are shown in Tables 5 to 7.

### EXPERIMENTAL EXAMPLE 1: MEASUREMENT OF THE LIGHT REFRACTIVE INDEX OF THE OPTICAL FILM

For the optical film, the refractive index (average of 450±20 nm) was measured using an ellipsometer, and the symbols according to the following standards are indicated in Tables 5 to 7 below.

⊚ When the measured value of the refractive index of the optical film is 1.25 or less

○: When the measured value of the refractive index of the optical film is 1.26 to 1.40

Δ: When the measured value of the refractive index of the optical film is 1.41 to 1.45

X: When the measured value of the refractive index of the optical film is greater than 1.45

### EXPERIMENTAL EXAMPLE 2: MEASUREMENT OF LIGHT TRANSMITTANCE OF THE OPTICAL FILM

For the optical film, average transmittance at 450±20 nm was measured using a UV-VIS spectrophotometer (Cary4000, Agilent), and indicated in Tables 5 to 7 with symbols according to the following standards.

○: When the average transmittance value is 90% or more

Δ: When the average transmittance value is greater than 80 and less than 90%

X: When the average transmittance value is less than 80%

### EXPERIMENTAL EXAMPLE 3: HAZE MEASUREMENT OF THE OPTICAL FILM

The haze was measured using a haze meter COH 400 manufactured by NIPPON DENSHOKU and indicated in Tables 5 to 7 with symbols according to the following standards.

○: When the haze value is 3.0 or less

Δ: When the haze value is greater than 3.0 and less than 4.0

X: When haze value is greater than 4.0

### EXPERIMENTAL EXAMPLE 4: VISCOSITY (ABSOLUTE VISCOSITY) MEASUREMENT OF COMPOSITION

Each of the photopolymerizable compositions of Reference Examples and Examples and the olefin-based monomer was measured by using a viscosity meter (product name: Brook Field viscometer) at a temperature of 25° C., and symbols according to the following standard are shown in Tables 5 to 7.

⊚ When the absolute viscosity value is 5 to 20 cP or less

○: When the absolute viscosity value is greater than 20 cP and 30 cP or less.

Δ: When the absolute viscosity value is greater than 30 cP and 40 cP or less.

X: When the absolute viscosity value is out of the above range.

### EXPERIMENTAL EXAMPLE 5: INKJET PROCESSABILITY EVALUATION

It was confirmed that the surface was formed by changing the nozzle temperature of the inkjet equipment, and it was indicated in Tables 5 to 7 with symbols according to the following standards.

Surface formation at nozzle temperature 25° C. to 45° C.=○

Surface formation at nozzle temperature above 45° C. to 50° C.=Δ

No surface formation at nozzle temperature 25° C. to 50° C. (Uncoating)=X

### EXPERIMENTAL EXAMPLE 6: EVALUATION OF SLIT COATING PROPERTIES

The coating properties were confirmed using Slit Coater equipment, and the thickness distribution was indicated in Tables 5 to 7 with symbols according to the following standards.

Thickness distribution within 5%=○

Thickness distribution within 10%=Δ

Thickness distribution greater than 10%=X

### EXPERIMENTAL EXAMPLE 7: ADHESIVENESS EVALUATION OF LOWER PORTION OF OPTICAL FILM

100 cells were cross-cut at 1 mm² interval on the cured film on the lower SiOₓ film, and adhesive strength with the lower SiOₓ film was compared using a tape.

The adhesiveness of lower portion of the optical film is shown in Tables 5 to 7 below as 0 to 5B according to the classification criteria of the adhesion test results of Table 4.

TABLE 4
Classification of Adhesion Test Results

| | Percent | Surface of Cross-Cut Area From Which |
|---|---|---|
| | Area | Flaking has Occured for Six Parallel Cuts |
| Classification | Removed | and Adhesion Range by Percent |
| 5B | 0% None | [symbol] |
| 4B | Less Than 5% | [symbol] |
| 3B | 5-15% | [symbol] |
| 2B | 15-35% | [symbol] |
| 1B | 35-65% | [symbol] |
| 0B | Greater Than 65% | [symbol] |

### EXPERIMENTAL EXAMPLE 8: ADHESIVENESS EVALUATION OF UPPER PORTION OF OPTICAL FILM

On the optical film, an SiOₓ film of 0.2 μm was further deposited through CVD process. 100 cells were cross-cut at 1 mm² interval on the upper SiOₓ film. Then, adhesive strength with the lower optical film having a low refractive index was compared using a tape.

According to the classification criteria of the adhesion test results in Table 3, the adhesiveness of the optical film was 0 to 5B, which is shown in Tables 5 to 7 below.

### EXPERIMENTAL EXAMPLE 9: HEAT RESISTANCE EVALUATION OF OPTICAL FILM

Heat resistance was measured using TGA (equipment name: Discovery TGA-55, TA KOREA) equipment. After sampling the pattern film formed during sensitivity measurement, the temperature was measured while raising the temperature from room temperature to 900° C. per minute by 10° C. using TGA equipment, and the following symbols are indicated in Tables 5 to 7 according to the following standards.

○: Temperature for TGA 5 wt % weight loss is 300° C. or more

Δ: Temperature for TGA 5 wt % weight loss is 270° C. or more and less than 300° C.

X: Temperature for TGA 5 wt % weight loss is less than 270° C.

TABLE 5

| | | | | | | | Low | Upper | |
|---|---|---|---|---|---|---|---|---|---|
| | Refractive | | | | Inkjet | Slit | portion | portion | Heat |
| Division | index | Transmittance | Haze | Viscosity | processability | Coating | adhesiveness | adhesiveness | resistance |
| Example 1 | ◯ | ◯ | ◯ | ◯ | ◯ | ◯ | 5B | 5B | ◯ |
| Example 2 | ◯ | ◯ | ◯ | ◯ | ◯ | ◯ | 5B | 5B | ◯ |
| Example 3 | ◯ | ◯ | ◯ | ◯ | ◯ | ◯ | 5B | 5B | ◯ |
| Example 4 | ◯ | ◯ | ◯ | ◯ | ◯ | ◯ | 5B | 5B | ◯ |
| Example 5 | ◯ | ◯ | ◯ | ◯ | ◯ | ◯ | 5B | 5B | ◯ |
| Example 6 | ◯ | ◯ | ◯ | ◯ | ◯ | ◯ | 5B | 5B | ◯ |
| Example 7 | ◯ | ◯ | ◯ | ◯ | ◯ | ◯ | 5B | 5B | ◯ |
| Example 8 | ◯ | ◯ | ◯ | ◯ | ◯ | ◯ | 5B | 5B | ◯ |
| Example 9 | ◯ | ◯ | ◯ | ◯ | ◯ | ◯ | 5B | 5B | ◯ |
| Example 10 | ◯ | ◯ | ◯ | ◯ | ◯ | ◯ | 5B | 5B | ◯ |
| Example 11 | ◯ | ◯ | ◯ | ◯ | ◯ | ◯ | 5B | 5B | ◯ |
| Example 12 | ◯ | ◯ | ◯ | ◯ | ◯ | ◯ | 5B | 5B | ◯ |
| Example 13 | ◯ | ◯ | ◯ | ◯ | ◯ | ◯ | 5B | 5B | ◯ |
| Example 14 | ◯ | ◯ | ◯ | ◯ | ◯ | ◯ | 5B | 5B | ◯ |
| Example 15 | ◯ | ◯ | ◯ | ◯ | ◯ | ◯ | 5B | 5B | ◯ |
| Example 16 | ◯ | ◯ | ◯ | ◯ | ◯ | ◯ | 5B | 5B | ◯ |
| Example 17 | ◯ | ◯ | ◯ | ◯ | ◯ | ◯ | 5B | 5B | ◯ |
| Example 18 | ◯ | ◯ | ◯ | ◯ | ◯ | ◯ | 5B | 5B | ◯ |
| Example 19 | ◯ | ◯ | ◯ | ◯ | ◯ | ◯ | 5B | 5B | ◯ |
| Example 20 | ◯ | ◯ | ◯ | ◯ | ◯ | ◯ | 5B | 5B | ◯ |
| Example 21 | ⊚ | ◯ | ◯ | ◯ | ◯ | ◯ | 5B | 5B | ◯ |
| Example 22 | ⊚ | ◯ | ◯ | ◯ | ◯ | ◯ | 5B | 5B | ◯ |
| Example 23 | ⊚ | ◯ | ◯ | ◯ | ◯ | ◯ | 5B | 5B | ◯ |
| Example 24 | ⊚ | ◯ | ◯ | ◯ | ◯ | ◯ | 5B | 5B | ◯ |
| Example 25 | ⊚ | ◯ | ◯ | ◯ | ◯ | ◯ | 5B | 5B | ◯ |
| Example 26 | ⊚ | ◯ | ◯ | ⊚ | ⊚ | ⊚ | 5B | 5B | ◯ |
| Example 27 | ⊚ | ◯ | ◯ | ⊚ | ⊚ | ⊚ | 5B | 5B | ◯ |
| Example 28 | ⊚ | ◯ | ◯ | ⊚ | ⊚ | ⊚ | 5B | 5B | ◯ |
| Example 29 | ⊚ | ◯ | ◯ | ⊚ | ⊚ | ⊚ | 5B | 5B | ◯ |
| Example 30 | ⊚ | ◯ | ◯ | ⊚ | ⊚ | ⊚ | 5B | 5B | ◯ |
| Example 31 | ◯ | ◯ | ◯ | ⊚ | ⊚ | ⊚ | 5B | 5B | ◯ |
| Example 32 | ◯ | ◯ | ◯ | ⊚ | ⊚ | ⊚ | 5B | 5B | ◯ |
| Example 33 | ◯ | ◯ | ◯ | ⊚ | ⊚ | ⊚ | 5B | 5B | ◯ |
| Example 34 | ◯ | ◯ | ◯ | ⊚ | ⊚ | ⊚ | 5B | 5B | ◯ |
| Example 35 | ◯ | ◯ | ◯ | ⊚ | ⊚ | ⊚ | 5B | 5B | ◯ |
| Example 36 | ◯ | ◯ | ◯ | ⊚ | ⊚ | ⊚ | 5B | 5B | ◯ |
| Example 37 | ◯ | ◯ | ◯ | ⊚ | ⊚ | ⊚ | 5B | 5B | ◯ |
| Example 38 | ◯ | ◯ | ◯ | ⊚ | ⊚ | ⊚ | 5B | 5B | ◯ |
| Example 39 | ◯ | ◯ | ◯ | ⊚ | ⊚ | ⊚ | 5B | 5B | ◯ |
| Example 40 | ◯ | ◯ | ◯ | ⊚ | ⊚ | ⊚ | 5B | 5B | ◯ |

TABLE 6

| | | | | | | | Low | Upper | |
|---|---|---|---|---|---|---|---|---|---|
| | Refractive | | | | Inkjet | Slit | portion | portion | Heat |
| Division | index | Transmittance | Haze | Viscosity | processability | Coating | adhesiveness | adhesiveness | resistance |
| Example 41 | ◯ | ◯ | ◯ | ⊚ | ⊚ | ⊚ | 5B | 5B | ◯ |
| Example 42 | ◯ | ◯ | ◯ | ⊚ | ⊚ | ⊚ | 5B | 5B | ◯ |
| Example 43 | ◯ | ◯ | ◯ | ⊚ | ⊚ | ⊚ | 5B | 5B | ◯ |
| Example 44 | ◯ | ◯ | ◯ | ⊚ | ⊚ | ⊚ | 5B | 5B | ◯ |
| Example 45 | ◯ | ◯ | ◯ | ⊚ | ⊚ | ⊚ | 5B | 5B | ◯ |
| Example 46 | ◯ | ◯ | ◯ | ⊚ | ⊚ | ⊚ | 5B | 5B | ◯ |
| Example 47 | ◯ | ◯ | ◯ | ⊚ | ⊚ | ⊚ | 5B | 5B | ◯ |
| Example 48 | ◯ | ◯ | ◯ | ⊚ | ⊚ | ⊚ | 5B | 5B | ◯ |
| Example 49 | ◯ | ◯ | ◯ | ⊚ | ⊚ | ⊚ | 5B | 5B | ◯ |
| Example 50 | ◯ | ◯ | ◯ | ⊚ | ⊚ | ⊚ | 5B | 5B | ◯ |
| Example 51 | ◯ | ◯ | ◯ | ⊚ | ⊚ | ⊚ | 5B | 5B | ◯ |
| Example 52 | ◯ | ◯ | ◯ | ⊚ | ⊚ | ⊚ | 5B | 5B | ◯ |
| Example 53 | ◯ | ◯ | ◯ | ⊚ | ⊚ | ⊚ | 5B | 5B | ◯ |
| Example 54 | ◯ | ◯ | ◯ | ⊚ | ⊚ | ⊚ | 5B | 5B | ◯ |
| Example 55 | ◯ | ◯ | ◯ | ◯ | ◯ | ◯ | 5B | 5B | ◯ |
| Example 56 | ◯ | ◯ | ◯ | ◯ | ◯ | ◯ | 5B | 5B | ◯ |
| Example 57 | ◯ | ◯ | ◯ | ◯ | ◯ | ◯ | 5B | 5B | ◯ |
| Example 58 | ◯ | ◯ | ◯ | ◯ | ◯ | ◯ | 5B | 5B | ◯ |
| Example 59 | ◯ | ◯ | ◯ | ◯ | ◯ | ◯ | 5B | 5B | ◯ |
| Example 60 | ◯ | ◯ | ◯ | ◯ | ◯ | ◯ | 5B | 5B | ◯ |
| Example 61 | ◯ | ◯ | ◯ | ◯ | ◯ | ◯ | 5B | 5B | ◯ |
| Example 62 | ◯ | ◯ | ◯ | ◯ | ◯ | ◯ | 5B | 5B | ◯ |
| Example 63 | ◯ | ◯ | ◯ | ◯ | ◯ | ◯ | 5B | 5B | ◯ |
| Example 64 | ◯ | ◯ | ◯ | ◯ | ◯ | ◯ | 5B | 5B | ◯ |

TABLE 7

| | | | | | | | Low | Upper | |
|---|---|---|---|---|---|---|---|---|---|
| | Refractive | | | | Inkjet | Slit | portion | portion | Heat |
| Division | index | Transmittance | Haze | Viscosity | processability | Coating | adhesiveness | adhesiveness | resistance |
| Comparative | ◯ | X | X | ◯ | ◯ | ◯ | OB | OB | X |
| Example 1 | | | | | | | | | |
| Comparative | ◯ | X | X | ◯ | ◯ | ◯ | OB | OB | X |
| Example 2 | | | | | | | | | |
| Comparative | ◯ | X | X | ◯ | ◯ | ◯ | OB | OB | X |
| Example 3 | | | | | | | | | |
| Comparative | ◯ | X | X | ◯ | ◯ | ◯ | OB | OB | X |
| Example 4 | | | | | | | | | |
| Comparative | ◯ | X | X | ◯ | ◯ | ◯ | OB | OB | X |
| Example 5 | | | | | | | | | |
| Comparative | ◯ | X | X | ◯ | ◯ | ◯ | OB | OB | X |
| Example 6 | | | | | | | | | |
| Reference | ◯ | Δ | Δ | Δ | Δ | Δ | OB | OB | Δ |
| Example 1 | | | | | | | | | |
| Reference | Δ | Δ | Δ | Δ | Δ | Δ | 5B | 5B | Δ |
| Example 2 | | | | | | | | | |
| Reference | Δ | ◯ | ◯ | ◯ | ◯ | ◯ | 5B | 5B | ◯ |
| Example 3 | | | | | | | | | |
| Reference | Δ | ◯ | ◯ | ◯ | ◯ | ◯ | 5B | 5B | ◯ |
| Example 4 | | | | | | | | | |
| Reference | ◯ | Δ | Δ | Δ | Δ | Δ | OB | OB | Δ |
| Example 5 | | | | | | | | | |
| Reference | ◯ | Δ | Δ | Δ | Δ | Δ | OB | OB | Δ |
| Example 6 | | | | | | | | | |
| Reference | ◯ | Δ | Δ | Δ | Δ | Δ | OB | OB | Δ |
| Example 7 | | | | | | | | | |
| Reference | ◯ | Δ | Δ | Δ | Δ | Δ | OB | OB | Δ |
| Example 8 | | | | | | | | | |
| Reference | Δ | ◯ | ◯ | ◯ | ◯ | ◯ | 5B | 5B | ◯ |
| Example 9 | | | | | | | | | |
| Reference | Δ | ◯ | ◯ | ◯ | ◯ | ◯ | 5B | 5B | ◯ |
| Example 10 | | | | | | | | | |
| Reference | ◯ | Δ | Δ | ◯ | Δ | Δ | OB | OB | Δ |
| Example 11 | | | | | | | | | |
| Reference | ◯ | Δ | Δ | ◯ | Δ | Δ | OB | OB | Δ |
| Example 12 | | | | | | | | | |
| Reference | ◯ | Δ | Δ | Δ | Δ | Δ | OB | OB | ◯ |
| Example 13 | | | | | | | | | |
| Reference | ◯ | Δ | Δ | Δ | Δ | Δ | OB | OB | ◯ |
| Example 14 | | | | | | | | | |
| Reference | ◯ | Δ | Δ | Δ | Δ | Δ | OB | OB | ◯ |
| Example 15 | | | | | | | | | |

It was confirmed that through the results of Experimental Examples 1 to 9 shown in Tables 5 to 7, the optical film, according to the present disclosure, has a very small refractive index, a very high average transmittance, a small haze measurement value, a high viscosity of the composition. It was also confirmed that the optical film, according to this disclosure, forms a surface at a nozzle temperature of 25° C. to 50° C. using inkjet equipment, forms a surface even when coated using slit coater equipment, has excellent adhesion to the upper and lower parts of the optical film, and also has excellent heat resistance.

The above description is merely an example of the present disclosure, and it will be understood by those skilled in the art to which the present disclosure belongs that the present disclosure may be implemented in a deformed form without departing from the essential characteristics of the present disclosure. Therefore, the disclosed embodiments should be considered from an illustrative rather than a limiting point of view. The scope of the present disclosure is indicated in the claims rather than the foregoing description, and all differences within the scope equivalent thereto should be construed as being included in the present disclosure.

1. A thermosetting composition comprising:
a thermosetting resin;
gas-containing particles; and
a monomer or oligomer having a thermosetting functional group, wherein the monomer or oligomer has two or more thermosetting functional groups.

2. The thermosetting composition of claim 1, wherein the thermosetting resin comprises at least one of an epoxy group, an oxetane group, or a hydroxyl group (OH).

3. The thermosetting composition of claim 1, wherein the thermosetting resin has a weight-average molecular weight in a range of 1,000 to 200,000.

4. The thermosetting composition of claim 1, wherein the gas-containing particles are comprised in an amount of 30 to 80% by weight based on the total weight of the thermosetting composition.

5. The thermosetting composition of claim 1, wherein the gas-containing particles are comprised in an amount of 50 to 80% by weight based on the total weight of the thermosetting composition.

6. The thermosetting composition of claim 1, wherein the gas-containing particles are porogen or hollow silica.

7. The thermosetting composition of claim 1, wherein the gas-containing particles are surface-treated with at least one functional group selected from the group consisting of an alkyl group, an acryl group, a methacrylic group, an epoxy group, and a vinyl group.

8. The thermosetting composition of claim 1, wherein the gas-containing particles are surface-treated to have a thickness in a range of 3 to 50 nm.

9. The thermosetting composition of claim 1, wherein the gas-containing particles have a D50 particle diameter in a range of 30 to 150 nm.

10. The thermosetting composition of claim 1, wherein the monomer or oligomer having the thermosetting functional group comprises an alicyclic epoxy structure.

11. The thermosetting composition of claim 1, wherein the monomer or oligomer having a thermosetting functional group comprises a compound having a chemical structure selected from the group consisting of Formulae 1 to 24: 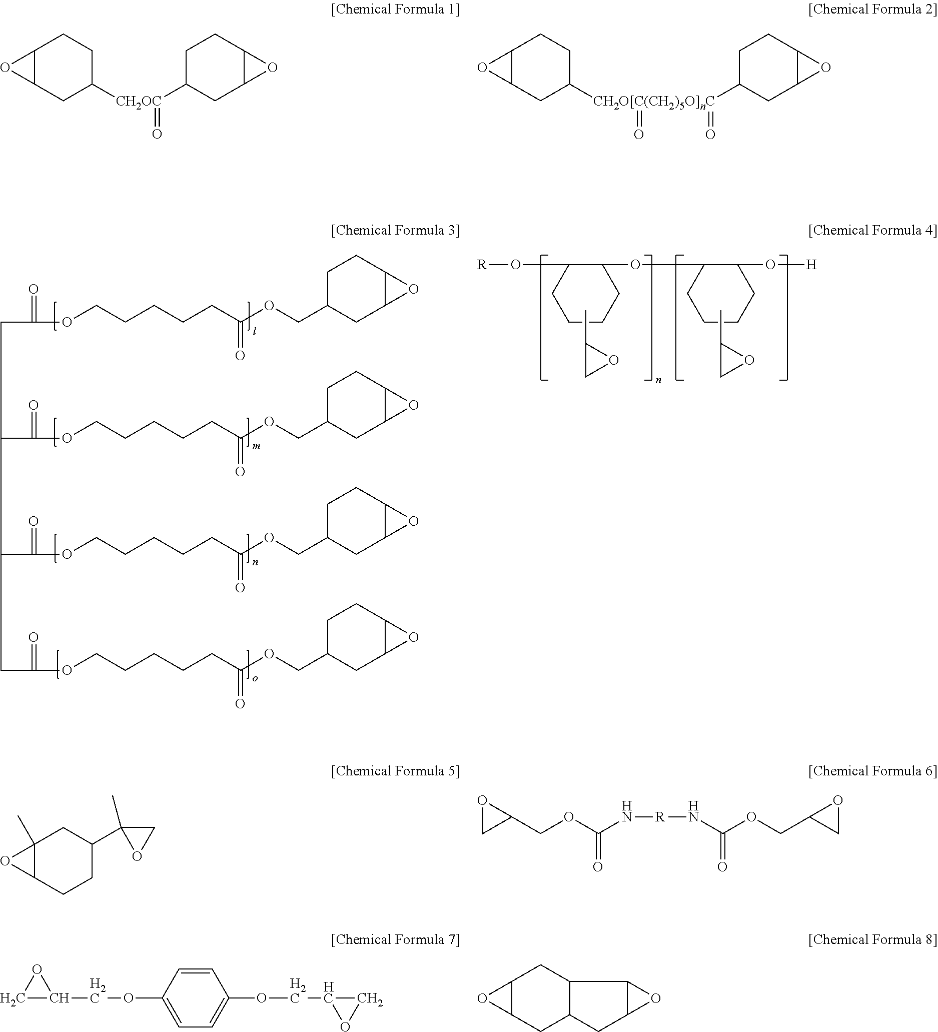 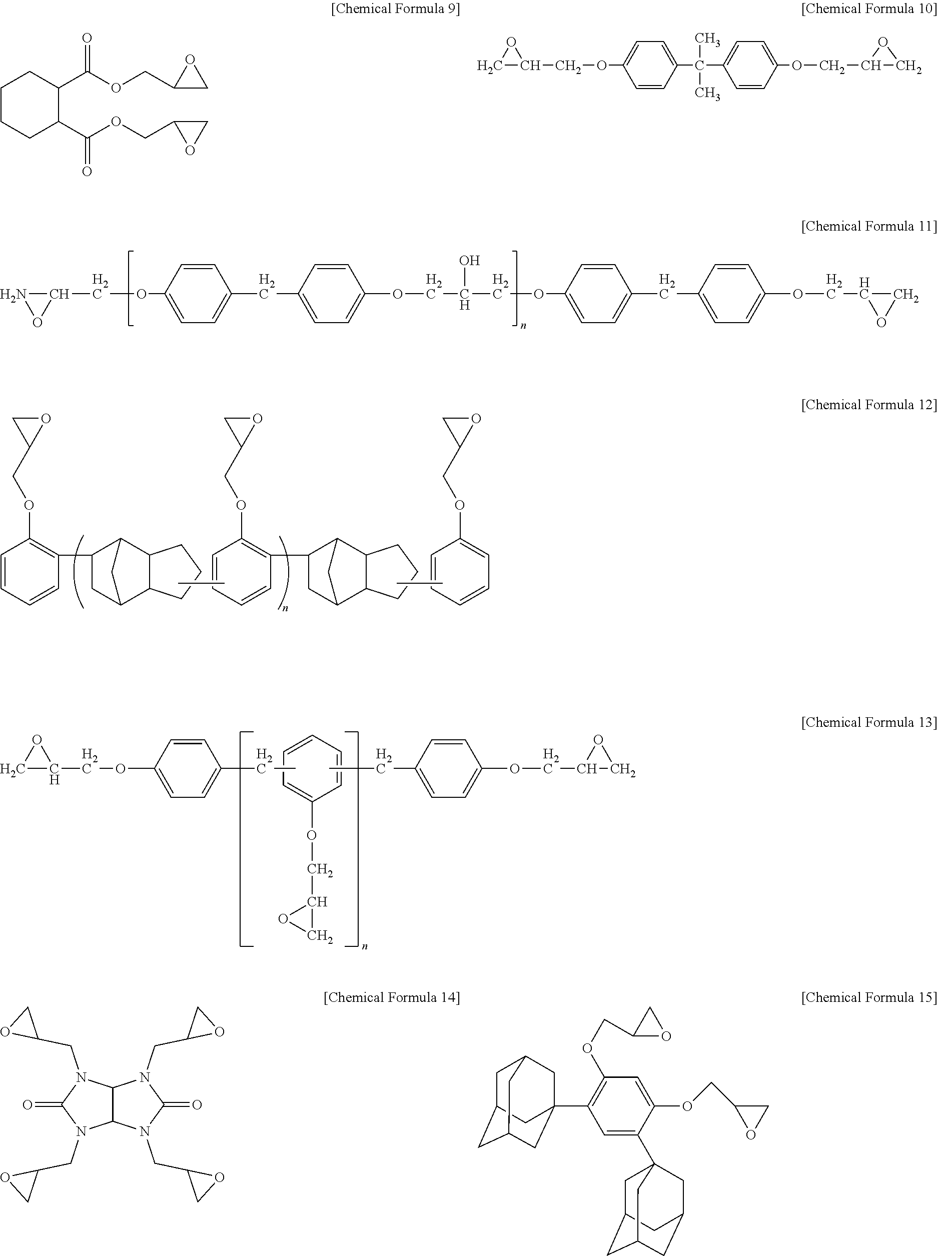 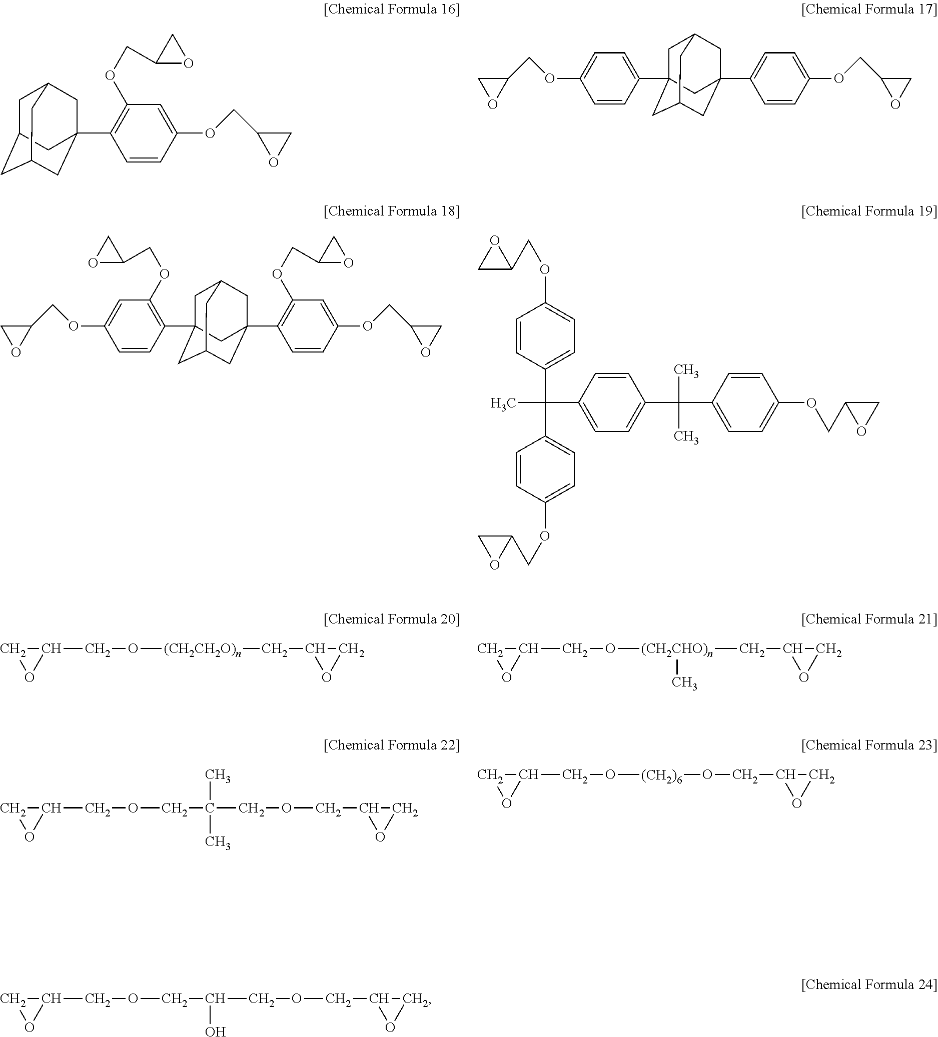
wherein, in Chemical Formula 4 and Chemical Formula 6, R each independently represents a hydrocarbon group having 1 to 10 carbon atoms, R in Chemical Formula 6 is one of alkyl, alkenyl, and alkoxy groups, and in Chemical Formulae 2 to 4, Chemical Formulae 11 and 23, Chemical Formulae 20 to 21, l, m, n, and o are each independently an integer of 1 to 30.

12. The thermosetting composition of claim 1, comprising:
1% to 69% by weight of the thermosetting resin;
30% to 80 parts by weight of the gas-containing particles; and
1% to 60% by weight of the monomer or oligomer having the thermosetting functional group.

13. The thermosetting composition of claim 1, wherein the total weight of the thermosetting resin and the monomer or oligomer having a thermosetting functional group is in a range of 20% to 70% by weight based on the total weight of the composition.

14. The thermosetting composition of claim 1, further comprising at least one additive selected from the group consisting of a silane coupling agent, an adhesive having, as a crosslinking site, an alkoxy group, and a surfactant.

15. The thermosetting composition of claim 1, further comprising at least one dispersant selected from the group consisting of an acrylic dispersant, an epoxy dispersant, and a silicone dispersant.

16. The thermosetting composition of claim 1, further comprising at least one crosslinking accelerator selected from the group consisting of a thermal acid generator and a thermal base generator.

17. The thermosetting composition of claim 1, wherein the thermosetting composition comprises one or more solvents selected from the group consisting of diethyleneglycoldimethyl ether, diethyleneglycolmethylethyl ether, propyleneglycolmethylether acetate, propyleneglycolethylether acetate, propyleneglycolpropylether acetate, propyleneglycolmethylether propionate, propyleneglycolethylether propionate, propyleneglycolpropylether propionate, propyleneglycolmethyl ether, propyleneglycolethyl ether, propyleneglycolpropyl ether, propyleneglycolbutyl ether, dipropyleneglycoldimethyl ether, dipropyleneglycoldiethyl ether, butyleneglycolmonomethyl ether, butyleneglycolmonoethyl ether, dibutyleneglycoldimethyl ether, dibutyleneglycoldiethyl ether, diethyleneglycolbutylmethyl ether, diethyleneglycolbutylethyl ether, triethyleneglycoldimethyl ether, triethyleneglycolbutylmethyl ether, diethyleneglycoltertiarybutyl ether, tetraethyleneglycoldimethyl ether, diethyleneglycolethylhexyl ether, diethyleneglycolmethylhexyl ether, dipropyleneglycolbutylmethyl ether, dipropyleneglycolethylhexyl ether, and dipropyleneglycolmethylhexyl ether.

18. The thermosetting composition of claim 1, wherein the thermosetting composition is a solvent-free thermosetting composition containing no solvents.

19. The thermosetting composition of claim 1, wherein the thermosetting composition has a viscosity in a range of 3 to 30 cP.

20. An optical member comprising:
a substrate; and
a cured film comprising the thermosetting composition of claim 1.

21. The optical member of claim 20, wherein the cured film has a haze percentage of 3% or less for the light of 450 nm wavelength.

22. A display device comprising the optical member of claim 20.
